(19) United States
(12) Patent Application Publication
(10) Pub. No.: US 2005/0124798 A1
(43) Pub. Date: Jun. 9, 2005

(54) Amphoteric polysaccharide composition and use

(76) Inventors: Francis Xavier Quinn, Paris (FR); Peyman Ghandchi, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/499,218

(22) PCT Filed: Nov. 22, 2002
(86) PCT No.: PCT/FR02/04016

(30) Foreign Application Priority Data
Dec. 18, 2001 (FR) 01/16388

(51) Int. Cl. C08B 37/08; C08B 5/08; C08B 31/00

(52) U.S. Cl. 536/18.7; 536/20; 536/42; 536/45

(57) ABSTRACT

The invention concerns an amphoteric polysaccharide comprising at least an anionic group and at least a cationic group borne directly by the polysaccharide, a composition comprising, in a physiologically acceptable medium, in particular cosmetically or pharmaceutically acceptable, said polysaccharide and the use of said polysaccharide or of said composition in particular for hair conditioning.

The present invention relates to the use of particular amphoteric polysaccharides in cosmetic compositions, especially in hair compositions.

It is known practice to use cationic polysaccharides in cosmetics, and especially in the field of hair conditioners. Specifically, cationic polysaccharides show strong interaction with the hair and thus make it possible to induce good conditioning properties. However, the polysaccharides thus modified may have certain drawbacks.

It has thus been proposed, by document EP 365 845, to use amphoteric or zwitterionic cellulose ethers in cosmetic compositions for treating the hair. These amphoteric polysaccharide derivatives show good water-solubility in the medium, especially in the presence of anionic surfactant.

It is also known practice, from document EP 797 979, to use amphoteric starches such as a starch modified with 2-chloroethylaminodipropionic acid, in combination with a fixing polymer, to obtain a hair composition that has excellent cosmetic properties such as softness, disentangling and feel, and also synergistic fixing and/or styling properties. The amphoteric starches described in said document have the structure St-O-R, in which St-O represents a starch molecule and R represents an amino alkyl group.

A skincare or haircare composition comprising, as thickener or emulsion stabilizer, an amino-multicarboxylic starch derivative is also known, from document EP 689 829. These derivatives also find an application in the paper industry, as reinforcers or retention agents, as illustrated by U.S. Pat. No. 5,455,340. In these two documents, the starch derivatives concerned have the structure St-O-(CH₂)n-R, in which St-O represents a starch molecule and R represents a substituted amine.

Amphoteric polysaccharide derivatives intended for treating keratin substances, especially the hair, are also known, for example from document EP 950 393. This document in particular describes amphoteric guar gum derivatives and especially an amphoteric guar gum comprising hydroxypropyltrimethylammonium groups.

It is thus found that all the amphoteric polysaccharides described in the prior art are of O-glycoside type, i.e. the substituents are borne by the saccharide via an oxygen-carbon bond, generally of ether or ester type.

Now, it has been found that amphoteric polysaccharide derivatives for which the bond is of ester type have the drawback of being readily hydrolyzable as a function of the variations in the pH of the medium. Compositions comprising them therefore have a certain measure of instability with respect to the pH, which may make the use of such compounds prohibitive.

It has moreover been found that the preparation of amphoteric polysaccharide derivatives for which the bond is of ether type is not easy, especially since these derivatives are partially degraded during their preparation, which is performed in basic medium (at about pH 11). Specifically, the use of sodium hydroxide results in a reduction in the degree of polymerization of the polysaccharides and thus a reduction in their molar mass, which is difficult to predict and to control.

There is thus still a need for amphoteric polysaccharides that do not have the drawbacks of the prior art and that are stable with respect to the medium comprising them, especially with respect to the pH, while at the same time not being readily degradable, and which may be easily and controllably prepared.

One subject of the present invention is an amphoteric polysaccharide comprising at least one anionic group and at least one cationic group directly borne by the polysaccharide, via a carbon-nitrogen covalent bond, said cationic group being chosen from the quaternary ammonium groups of formula:
—N⁺R₁R₂R₃
and the quaternizable groups of formula:
—NR′₁R′₂
in which:

R₁, R₂, R₃, R′₁ and R′₂ represent, independently of each other, a linear, branched or cyclic, saturated or unsaturated, C₁-C₅₀ hydrocarbon-based radical optionally comprising one or more hetero atoms such as nitrogen, oxygen, sulfur or phosphorus atoms.

Another subject of the invention is a composition comprising, in a physiologically acceptable medium, especially a cosmetically or pharmaceutically acceptable medium, at least one polysaccharide as defined above.

Another subject of the invention is the use of at least one polysaccharide as defined above, and/or of a composition comprising it, to condition the hair, and/or to improve the disentangling, softness and sheen properties of the hair.

In the context of the present invention, the term “amphoteric polysaccharide” means amphoteric polymers thus comprising at least one anionic group and at least one cationic group, and polymers that may be made amphoteric, for example comprising a quaternizable amine group and/or an acid group.

The initial polysaccharide may be chosen from any linear or branched, hydrocarbon-based, synthetic, natural or modified natural polymer consisting of monosaccharide units linked via glycoside bonds.

This polysaccharide may be of plant, bacterial, animal or marine origin.

Preferably, an initial polysaccharide that will allow the preparation of a water-soluble or water-dispersible amphoteric polysaccharide is chosen. Said initial polysaccharide may itself be advantageously water-soluble or water-dispersible.

The term “water-soluble polysaccharide” means a polysaccharide having a solubility in water of at least 0.1% by weight, at 20° C. under a pressure of 1.013×10⁵ Pa.

The term “water-dispersible polysaccharide” means a polysaccharide having the capacity to form a dispersion, i.e. a two-phase system in which the first phase is formed from finely divided particles uniformly distributed in the continuous second phase. Water-dispersible polymers generally have a transparent to bluish appearance. Their transparency may be measured by means of a coefficient of transmittance at 600 nm ranging from 10% to 90%, or alternatively by means of a turbidity ranging from 60 to 600 NTU (turbidity measured using a Hach model 2100 P portable turbidimeter).

The polysaccharides used to prepare the amphoteric polysaccharides according to the invention may be initially neutral, cationic or anionic.

Among the initially neutral polysaccharides from which the amphoteric polysaccharide according to the invention may be prepared, mention may be made of pullulan, cellulose and certain derivatives thereof such as hydroxyethylcellulose, hydroxypropylcellulose, hydroxypropylmethylcellulose or methylcellulose; guar gum and certain derivatives such as a hydroxyethyl guar or hydroxypropyl guar gum; starch and neutral derivatives thereof, such as hydroxyethyl starch or hydroxypropyl starch; dextran; carob gum; chitin, chitosan; polydextrose; konjac mannan.

Among the initially anionic polysaccharides from which the amphoteric polysaccharide according to the invention may be prepared, mention may be made of xylan, pectin, alginic acid, sodium, potassium or ammonium alginate; certain cellulose derivatives such as carboxymethylcellulose; certain guar gum derivatives, such as a carboxymethyl guar gum or a carboxymethylhydroxypropyl guar gum; certain starch derivatives, for instance starch acetate or a carboxymethyl starch; agar-agar, carrageenans, a furcellaran, a gellan gum, a xanthan gum, a gum arabic, a gum tragacanth, hyaluronic acid; certain chitosan derivatives, such as an N,O-carboxymethylchitosan, an N-hydroxyalkylchitosan or an O-carboxymethylchitosan.

Among the initially cationic polysaccharides from which the amphoteric polysaccharide according to the invention may be prepared, mention may be made of certain guar derivatives, such as quaternized guar gum derivatives, such as Jaguar; certain quaternized starch derivatives, such as a 2-hydroxy-3-(trimethylammonium)-propyl starch chloride; certain quaternized cellulose derivatives, such as a 2-hydroxypropyltrimethylammonium ethylcellulose chloride; quaternized chitosan derivatives.

When the initial polysaccharide does not bear an anionic group, it is necessary to functionalize it by grafting at least one anionic group via covalent bonding.

Such anionic groups, initially present on the polysaccharide or grafted thereon, may be chosen from Bronsted acid groups (as defined in Advanced Organic Chemistry by J. March, published by John Wiley & Sons, New York, 1992). Mention may be made especially of carboxylic acid, phosphoric acid, phosphonic acid, sulfonic acid, sulfenic acid and pyruvic acid groups.

The anionic group is preferably a carboxylic acid group.

The anionic group may also be in the form of an acid salt, especially a sodium, calcium, lithium or potassium salt.

The anionic group may be either directly borne by the polysaccharide, or spaced from the polysaccharide via a side graft. Said side graft may be a linear, branched, cyclic, saturated or unsaturated hydrocarbon-based divalent radical containing 1 to 50 carbon atoms, especially 1 to 16 carbon atoms, optionally comprising one or more heterb atoms chosen from nitrogen, oxygen, sulfur and/or phosphorus. Mention may especially be made of the following divalent radicals: methylene, ethylene, propylene, butylene. Said graft is linked to the polysaccharide via a covalent bond. Preferably, they are covalent bonds that are not hydrolyzable under the final conditions of use of the amphoteric polysaccharide, i.e. in water, in the presence of a standard cosmetic surfactant, at 20° C. and at atmospheric pressure.

When the initial polysaccharide does not bear a cationic group, it is necessary to functionalize it by grafting at least one cationic group via covalent bonding.

The polysaccharide according to the invention is characterized in that the cationic group(s) is (are) directly borne by the polysaccharide, via a carbon-nitrogen covalent bond, and replace(s) a hydroxyl radical initially present in the polysaccharide.

The amphoteric polysaccharide according to the invention may comprise several cationic groups, which may be identical or different.

The cationic group is a quaternary ammonium group of formula:
—N⁺R₁R₂R₃
or a quaternizable group of formula:
—NR′₁R′₂
in which:

R₁, R₂, R₃, R′₁ and R′₂ represent, independently of each other, a linear, branched or cyclic, saturated or unsaturated C₁-C₅₀ hydrocarbon-based radical, optionally comprising one or more hetero atoms such as nitrogen, oxygen, sulfur or phosphorus atoms.

The quaternary ammonium group may also be in salt form, especially in the form of halide such as a chloride or a bromide.

Preferably, R₁, R₂, R₃, R′₁ and/or R′₂ are chosen, independently of each other, from saturated linear hydrocarbon-based groups containing. 1 to 18 and better still 1 to 8 carbon atoms, and in particular from methyl, ethyl, propyl, butyl, hexyl and octyl groups.

The degree of anionic substitution (DS(−)) of the amphoteric polysaccharides according to the invention represents the ratio of the number of hydroxyls substituted with an anionic group in the repeating unit to the number of elemental monosaccharides constituting the unit. This degree may preferably range from 0.01 to 0.9, especially from 0.05 to 0.8 and preferably from 0.1 to 0.7.

The degree of cationic substitution (DS(+)) of the amphoteric polysaccharides according to the invention represents the ratio of the number of hydroxyls substituted with a cationic group in the repeating unit to the number of elemental monosaccharides constituting the unit. This degree may preferably range from 0.01 to 0.9, especially from 0.05 to 0.8 and preferably from 0.1 to 0.7.

The amphoteric polysaccharide according to the invention may be prepared by any method known to those skilled in the art.

The amphoteric polysaccharide according to the invention may be present in the compositions in concentrations ranging from 0.01% to 20% by weight, especially from 0.1% to 10% by weight and preferably from 0.5% to 5% by weight relative to the total weight of the composition comprising it.

This composition comprises a physiologically acceptable medium, i.e. a medium that is compatible with any keratin material, such as the skin, the scalp, the nails, mucous membranes, the eyes and the hair or any other area of body skin. This composition may be a cosmetic or pharmaceutical composition and may thus comprise a cosmetically or pharmaceutically acceptable medium.

The physiologically acceptable medium may consist solely of water or of a mixture of water and of a solvent such as a C₁-C₈ alcohol, such as ethanol, isopropanol, tert-butanol or n-butanol; a polyol such as glycerol; a glycol, for instance butylene glycol, isoprene glycol, propylene glycol or polyethylene glycols such as PEG-8; polyol ethers.

The compositions according to the invention may also contain one or more additives such as anionic, amphoteric, zwitterionic, nonionic or cationic fixing or nonfixing polymers; surfactants; nacreous agents; opacifiers; organic solvents; fragrances; thickeners; gelling agents; oils and/or waxes of mineral, plant, animal or synthetic origin; fatty acid esters; dyes, branched or unbranched, cyclic or acyclic, organomodified or non-organomodified, volatile or nonvolatile silicones; mineral or organic particles; pigments and fillers; preserving agents; cosmetic active agents; sunscreens; pH stabilizers.

Needless to say, a person skilled in the art will take care to select this or these optional additional compound(s), and/or the amount thereof, such that the advantageous properties of the composition according to the invention are not, or are not substantially, adversely affected by the envisaged addition.

The composition according to the invention may be in any presentation form that is suitable for topical application, and especially in the form of an aqueous or aqueous-alcoholic gel, a water-in-oil, oil-in-water or multiple emulsion, an aqueous dispersion based on ionic and/or nonionic lipid vesicles, containing or not containing a dispersed oil. It may be in the form of a serum, a cream, a milk, a thickened or unthickened lotion, or a mousse.

The composition according to the invention may be used for treating and caring for facial and/or body skin, mucous membranes (lips), the scalp and/or the hair.

It thus finds a particular application as a facial care cream, a shower gel, a bath gel, a hair dye composition, a composition for permanently reshaping the hair, a composition for cleansing and/or removing makeup from the face, an antisun composition; hair cleansing compositions such as a shampoo or a rinse-out or leave-in conditioner; rinse-out compositions, to be applied before or after dyeing, bleaching, permanent-waving or relaxing the hair or alternatively between the two steps of a permanent-waving or hair-relaxing operation; a hair composition for holding the hairstyle, such as a styling lacquer, gel, mousse or spray.

The compositions according to the invention may advantageously be used as hair products, especially rinse-out or leave-in products, in particular for washing, caring for, conditioning, holding the hairstyle of, shaping, dyeing, bleaching, permanently reshaping or relaxing the hair.

They are more particularly styling products such as fixing and/or styling compositions, and especially styling and/or fixing lacquers, sprays, gels or mousses, or conditioners.

Specifically, it has been found that the polysaccharides according to the invention make it possible to improve the disentangling, softness and sheen properties of hair treated using compositions comprising them. They may thus advantageously be used in hair conditioning compositions.

The invention is illustrated in greater detail in the examples that follow.

### EXAMPLE 1

15 g of xylan are dispersed in 300 ml of dimethylacetamide (DMA) in a 2 liter round-bottomed flask, in the absence of traces of moisture. The mixture is heated at 120° C. with stirring for 2 hours and is then cooled to 100° C. 22.5 g of lithium chloride are added and stirring is continued at 25° C. for 3 hours until a clear solution is obtained. This mixture is cooled to 8° C. and a solution of 48.8 ml of triethylamine in 50 ml of DMA is added, followed by addition of a solution of 17.6 g of tosyl chloride in 36 ml of DMA.

The resulting mixture is mixed for 24 hours and the tosyl xylan is then precipitated from 5 liters of ice-cold water, recovered, washed with water and then with ethanol, and dried under vacuum at 50° C.

1 g of tosyl xylan is dissolved in 50 ml of DMA at 20° C.; after dissolution, 10 ml of water and then 6 g of triethylamine are added. This mixture is heated at 100° C. for 24 hours and is then cooled to 20° C. and the quaternized xylan is precipitated from 400 ml of acetone. The precipitate is separated out, washed and dried under vacuum at 50° C. for 24 hours.

An amphoteric xylan bearing carboxylic groups and triethylammonium groups is obtained.

### EXAMPLE 2

A styling gel is prepared, comprising (AM:active material):

| | | |
|---|---|---|
| polysaccharide of Example 1 | | 0.5 g |
| fixing polymer | | 0.5 g AM |
| crosslinked polyacrylic acid | | 0.6 g AM |
| ethanol | | 8.5 g |
| triethanolamine | qs | pH 7.5 |
| water | qs | 100 g |

1-12. (canceled)

13. An amphoteric polysaccharide comprising at least one anionic group and at least one cationic group directly attached to the polysaccharide, via a carbon-nitrogen covalent bond, wherein said at least one cationic group is chosen from quaternary ammonium groups of formula:
—N⁺R₁R₂R₃
and quaternizable groups of formula:
‥NR′₁R′₂
wherein:
R₁, R₂, R₃, R′₁, and R′₂, which may be identical or different, are chosen from linear, branched and cyclic, saturated and unsaturated, C₁-C₅₀ hydrocarbon-based radicals optionally comprising one or more heteroatoms chosen from nitrogen, oxygen, sulfur, and phosphorus atoms.

14. The polysaccharide according to claim 13, wherein R₁, R₂, R₃, R′₁, and R′₂, which may be identical or different, are chosen from saturated linear hydrocarbon-based groups containing from 1 to 18 carbon atoms.

15. The polysaccharide according to claim 14, wherein R₁, R₂, R₃, R′₁, and R′₂, which may be identical or different, are chosen from methyl, ethyl, propyl, butyl, hexyl, and octyl groups.

16. The polysaccharide according to claim 13, wherein the quaternary ammonium group is in salt form.

17. The polysaccharide according to claim 16, wherein the quarternary ammonium group in salt form is a halide.

18. The polysaccharide according to claim 13, wherein the at least one anionic group is a Brönsted acid group.

19. The polysaccharide according to claim 18, wherein the at least one anionic group is chosen from carboxylic acid, phosphoric acid, phosphonic acid, sulfonic acid, sulfenic acid, and pyruvic acid groups.

20. The polysaccharide according to claim 13, wherein the at least one anionic group is in the form of an acid salt.

21. The polysaccharide according to claim 20, wherein the acid salt is chosen from sodium, calcium, lithium, and potassium salts.

22. The polysaccharide according to claim 13, wherein the polysaccharide is of plant, bacterial, animal or marine origin.

23. The polysaccharide according to claim 13, wherein said polysaccharide is initially neutral, initially anionic, or initially cationic.

24. The polysaccharide according to claim 23, wherein the initially neutral polysaccharide is chosen from pullulan, cellulose, hydroxyethylcellulose, hydroxypropylcellulose, hydroxypropylmethylcellulose, methylcellulose, guar gum, hydroxyethyl guar gum, hydroxypropyl guar gum, starch, hydroxyethyl starch, hydroxypropyl starch, dextran, carob gum, chitin, chitosan, polydextrose, and konjac mannan.

25. The polysaccharide according to claim 23, wherein the initially anionic polysaccharide is chosen from xylan, pectin, alginic acid, sodium alginate, potassium alginate, ammonium alginate, carboxymethylcellulose, carboxymethyl guar gum, carboxymethylhydroxypropyl guar gum, starch acetate, carboxymethyl starch, agar-agar, carrageenans, furcellaran, gellan gum, xanthan gum, gum arabic, gum tragacanth, hyaluronic acid, N,O-carboxymethylchitosan, N-hydroxyalkylchitosan, and O-carboxymethylchitosan.

26. The polysaccharide according to claim 23, wherein the initially cationic polysaccharide is chosen from quaternized guar gum, 2-hydroxy-3-(trimethylammonium)-propyl starch chloride, 2-hydroxypropyltrimethylammonium ethylcellulose chloride, and quaternized chitosan derivatives.

27. A composition comprising, in a physiologically acceptable medium, at least one amphoteric polysaccharide comprising at least one anionic group and at least one cationic group directly attached to the polysaccharide, via a carbon-nitrogen covalent bond, wherein said at least one cationic group is chosen from quaternary ammonium groups of formula:
—N⁺R₁R₂R₃
and quaternizable groups of formula:
—NR′₁R′₂
wherein:
R₁, R₂, R₃, R′₁, and R′₂, which may be identical or different, are chosen from linear, branched and cyclic, saturated and unsaturated, C₁-C₅₀ hydrocarbon-based radicals optionally comprising one or more heteroatoms chosen from nitrogen, oxygen, sulfur, and phosphorus atoms.

28. The composition according to claim 27, wherein the physiologically acceptable medium is a cosmetically acceptable medium or a pharmaceutically acceptable medium.

29. The composition according to claim 27, wherein the at least one polysaccharide is present in an amount ranging from 0.01% to 20% by weight, relative to the total weight of the composition.

30. The composition according to claim 29, wherein the amount ranges from 0.1% to 10% by weight.

31. The composition according to claim 30, wherein the amount ranges from 0.5% to 5% by weight.

32. The composition according to claim 27, in the form of a facial care cream, a shower gel, a bath gel, a hair dye composition, a composition for permanently reshaping the hair, a composition for cleansing and/or removing makeup from the face, a sunscreen composition; a hair cleansing composition; a rinse-out composition for hair, to be applied before or after dyeing, bleaching, permanent-waving or relaxing the hair or alternatively between the two steps of a permanent-waving or hair-relaxing operation; or a hair composition for holding a hairstyle.

33. The composition according to claim 27, in the form of a rinse-out or leave-in hair product.

34. The composition according to claim 33, wherein the rinse-out or leave-in hair product is used for washing, caring for, conditioning, holding the hairstyle of, shaping, dyeing, bleaching, permanently reshaping or relaxing the hair.

35. The composition according to claim 33, wherein the rinse-out or leave-in hair product is a fixing and/or styling composition.

36. The composition according to claim 35, wherein the fixing and/or styling composition is a lacquer, spray, gel, mousse or conditioner.

37. A method of conditioning the hair, and/or improving the disentangling, softness and sheen properties of the hair, which comprises applying to hair at least one amphoteric polysaccharide comprising at least one anionic group and at least one cationic group directly attached to the polysaccharide, via a carbon-nitrogen covalent bond, wherein said at least one cationic group is chosen from quaternary ammonium groups of formula:
—N⁺R₁R₂R₃
and quaternizable groups of formula:
—NR′₁R′₂
wherein:
R₁, R₂, R₃, R′₁, and R′₂, which may be identical or different, are chosen from linear, branched and cyclic, saturated and unsaturated, C₁-C₅₀ hydrocarbon-based radicals optionally comprising one or more heteroatoms chosen from nitrogen, oxygen, sulfur, and phosphorus atoms.

38. The method according to claim 37, wherein the at least one polysaccharide is in a physiologically acceptable medium.
